(19) United States
(12) Patent Application Publication
(10) Pub. No.: US 2006/0036959 A1
(43) Pub. Date: Feb. 16, 2006

(54) Common user interface for accessing media

(76) Inventors: Chris Heatherly, Monrovia, CA (US); Cordell Ratzlaff, Palo Alto, CA (US); Phillip Bensaid, San Francisco, CA (US); Mei-Yan Chan, Atlanta, GA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/198,599

(22) Filed: Aug. 4, 2005

Related U.S. Application Data
(60) Provisional application No. 60/599,562, filed on Aug. 5, 2004.

(51) Int. Cl. G06F 3/00

(52) U.S. Cl. 715/764

(57) ABSTRACT

A user interface for a computer or the like for accessing media files. The interface includes a resizable window displaying a preview image of each of a plurality of media files and providing access thereto for use in at least one of a plurality of applications.

### CROSS REFERENCE TO RELATED APPLICATION

This application is a non-provisional application which claims the benefit of a provisional application Ser. No. 60/599,562 filed Aug. 5, 2004, the content of which is incorporated by reference herein in its entirety.

### BACKGROUND

1. Field of the Invention

This invention relates to providing a common user interface for accessing media from a plurality of applications.

2. Related Art

Generally, accessing files on a computer or from a computer program involves navigating through a directory structure to locate files. The user generally needs to have some knowledge of where the file is located within the directory structure, and also must have some knowledge of the layout of the directory structure in order to locate the file.

A user may know the folder or directory name of where a file is located. However, the directory is usually nested within a tree of other directories. If the user does not know the path to follow from directory to directory in order to reach the desired directory, the user may have difficulty locating the file. For example, the user may know that a file is located in a directory named “my files.” However, if the user does not also know that “my files” is located as follows, C:\documents\user\my files, the user may have difficulty locating the file.

Files are also often accessed using a drop down menu, and the user must navigate through a directory structure. This can be a cumbersome process when several files are to be accessed.

This can be a problem for children who are not readily aware of how a directory structure and full file paths work.

### SUMMARY OF THE INVENTION

A common user interface (UI) for accessing files from a plurality of applications is therefore provided. The user interface is designed to “look and feel” the same in a plurality of application environments. The user interface also eliminates the need to know the file path or directory structure, or even the location where files have been saved. The common user interface provides consistency across a plurality of applications and provides ease of use in accessing files for children or those not skilled in the use of computers.

In one embodiment, a common user interface for accessing files is provided to a suite of applications. For example, the suite of applications may comprise media applications such as image, audio, and video applications. The common user interface is provided to each application, and its functions and features remain consistent in each application. In such an embodiment, the common user interface is used to access media assets such as images, backgrounds, photos, music, sound effects, video files, etc.

In one embodiment, the common user interface for accessing files is a graphical user interface and features drag and drop functionality. In one aspect, the common user interface comprises a window. The common user interface can optionally be resized and moved. The common user interface can be resized to take up the full screen, a portion of the screen, or can be displayed in a minimized form. In one aspect, the common user interface is always present on the screen, thereby eliminating the need to “File, Open” each time a user desires to open or access a file.

In one embodiment, the common user interface displays a preview of the files available, such as thumbnail images.

In one embodiment, the common user interface simplifies navigation of data by dividing the data into categories. For example, in one embodiment, media assets are divided into two categories. One category comprises media assets that are created and/or stored by the user. A second category comprises pre-provided media assets such as templates or media that is provided with the application. For example, pre-provided media may comprise backgrounds, stickers, windows and frames, scenes, wallpapers, sounds such as instruments, sound effects, melodies, video clips, music, animations, etc.

In another embodiment, additional categories are provided. For example, additional categories may be provided which display data created in another application, which is available for importation into the application currently in use.

Further categorization of the data may be included to filter what is displayed within the common user interface. One or more menus may be present within the common user interface which allow the user to further select the type of data to be viewed. For example, the user may select to view “all” media assets. Alternatively, the user may select to view “backgrounds.”

In some embodiments, the common user interface displays only certain types of media based on what is applicable to the application being used. For example, when an image based application is used, media such as music and video may not be displayed within the common user interface. However, in a video based application, media types such as images and sound may be included and accessed.

The common user interface can be used to move media from one application to another easily. For example, a sound created within one application can be easily imported into a video in a video application by dragging the sound from the common user interface into the video application.

The foregoing and other objects, features, and advantages of the present invention will be become apparent from a reading of the following detailed description of exemplary embodiments thereof, which illustrate the features and advantages of the invention in conjunction with references to the accompanying drawing Figures.

### BRIEF DESCRIPTION OF THE DRAWINGS

FIGS. 1-8 are pictorial illustrations of a series of screen shots of an exemplary common user interface as accessed in an image creation application.

FIGS. 9-16 are pictorial illustrations of a series of screen shots of an exemplary common user interface as accessed in an audio creation application.

FIGS. 17-21 are pictorial illustrations of a series of screen shots of an exemplary common user interface as accessed in a video creation application.

### DETAILED DESCRIPTION OF THE PREFERRED EMBODIMENT

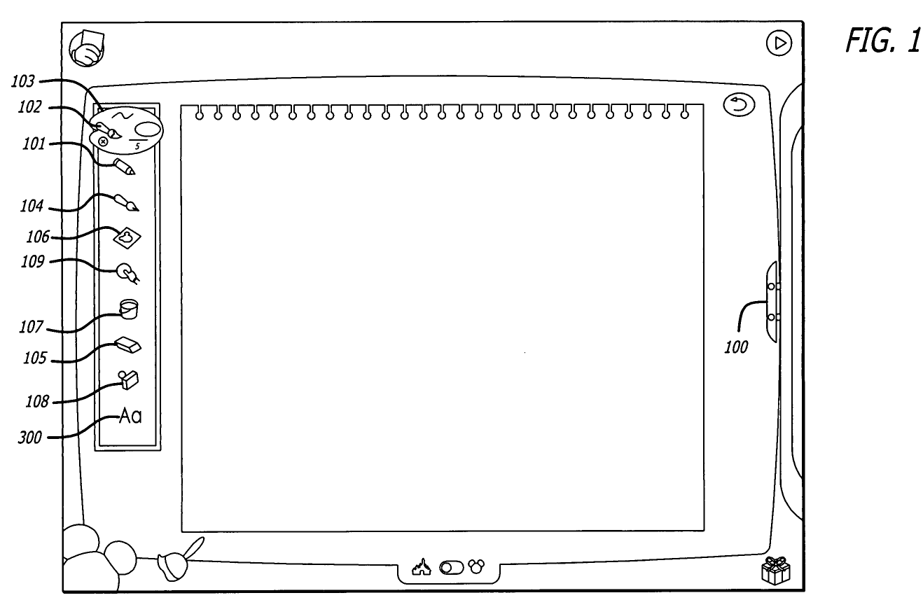

FIGS. 1-21 are screen shots of exemplary common user interfaces for accessing files in accordance with the present disclosure, as accessed from a first application. In this embodiment, the first application is an image creation application.

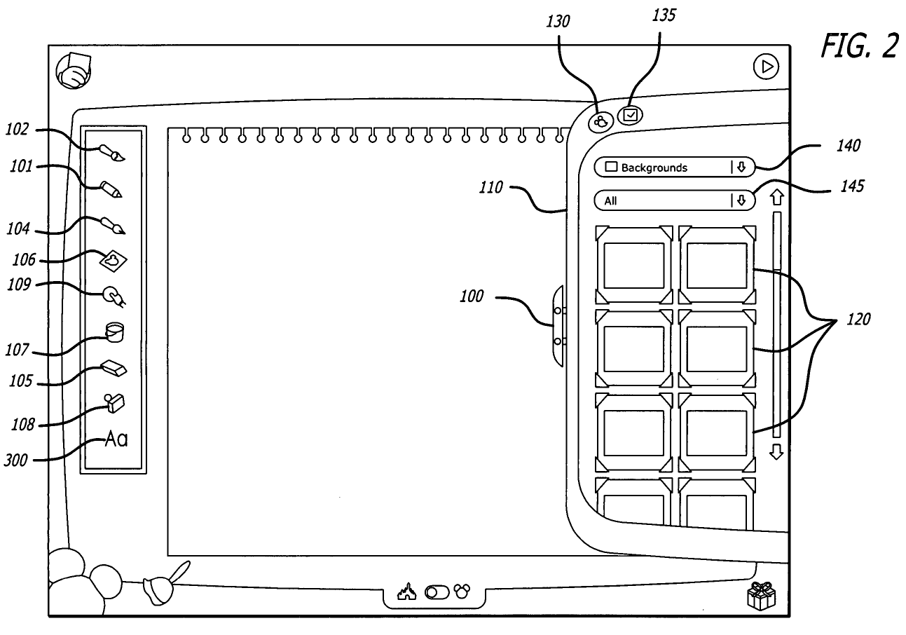

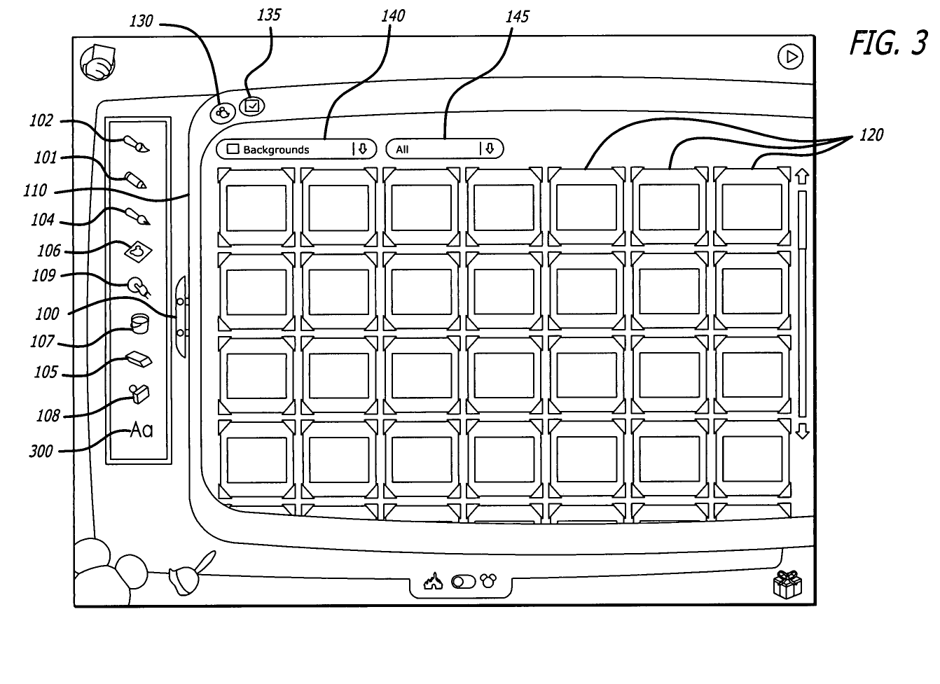

FIG. 1 illustrates an exemplary embodiment of the common user interface, as shown in a minimized form. In the embodiment shown, the common user interface features a graphical handle 100 which is used to open and close, or resize the window 110 (FIG. 2) of the common user interface. Furthermore, in the embodiment shown, the window 110 resembles a drawer where files are “stored.” FIG. 2 illustrates how the common user interface can be resized to take up a portion of the screen. Thumbnail images 120 are shown within the window 110 of the common user interface. FIG. 3 shows how the common user interface can be sized to take up a majority of the screen or the entire screen.

A series of tools are provided in the left side of the screen for creating, editing and transforming graphics. For example, the pencil icon 101 is used to draw pencil lines, the brush icon 102 is used to draw brush lines (the thickness of which can be varied—see box 103). Thus, the user can create images on the screen using the tools provided.

The following tools are thus available for the user to create graphics:

Marking tools—These are tools that enable users to lay down lines and fill in different shapes, sizes, and textures. There are several basic tool types, but each tool type can have multiple variations. All tools come in multiple sizes and may have additional modifiers such as pattern selections or drop shadow effects. The tool types are:
Brush (see icon 102)
   Spray Paint
   Paint Can
Pen (see icon 104)
   Marker/Highlighter
   Glue Pen—Transparent, reflective and dimensional mark
Pencil (see icon 101)
   Pencil Bundle
   Crayon
   Chalk
Eraser: soft edge, hard edge (see icon 105)
   Magic eraser
   Blur—smoothes rough edges by averaging pixels next to defined lines and shaded areas of an image
   Smudging/Distortion tools
   Etch-a-sketch®, a registered trademark of Ohio Art Company for a game board that can be drawn on, then erased by shaking the entire paint board.
Text tool (see icon 300)
Shape Stencil Tool—Used to select from a variety of different shapes (see icon 106)
Select stencil
Select attributes:
   Outline, Outline color
   Orientation
Manipulation Tools (see icon 107)
Doodlebots—a paint spraying icon
Image Tube—Paints with animated patterns
Paint bucket—The paint bucket can apply the following types of fills to objects:
   Solid fill
   Gradient fill
   Pattern fill
Rubber Stamp—(see icon 108) duplicates a selected area of an image to another location
Undo—As elsewhere in the application, multiple undos are supported
Editing tools are used in conjunction with the following palettes:
   Color
   Pattern
   Brush (allows selection from multiple brush shapes and sizes)
Selection Tool (see icon 109)

Obviously many other tools, color and pattern tools, graphic transformation tools, text tools, zoom tools, crop tools, special effects tools, save tools, viewing tools, etc. may be provided.

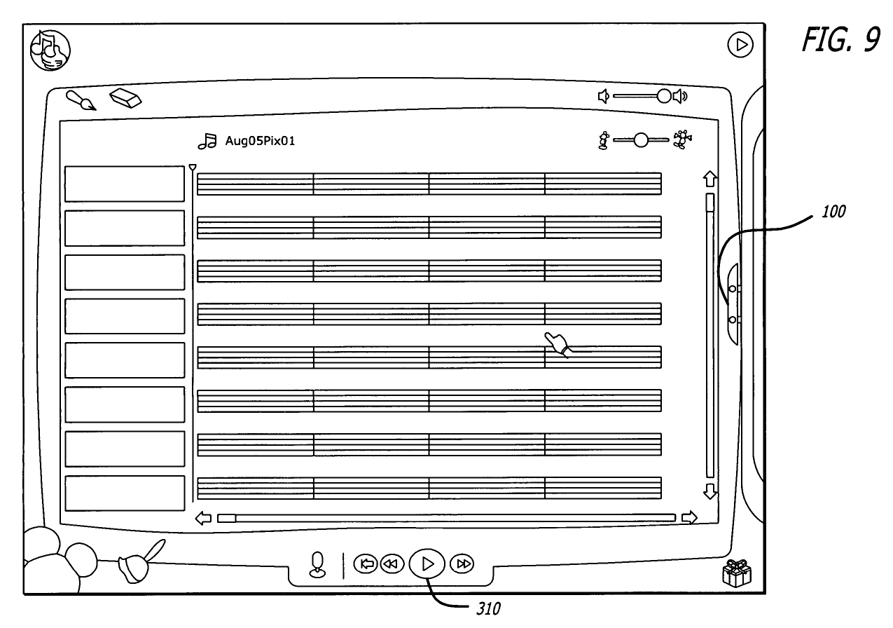

In FIGS. 9-21, conventional controls 310, such as play, forward, reverse, fast-reverse, etc. may be provided for playing videos, movies, etc.

As can be seen from the drawings, the common user interface includes icons 130 and 135. These icons represent different categories of data. One category comprises media assets that are created and/or stored by the user. A second category comprises pre-provided media assets such as templates or media that is provided with the application. For example, pre-provided media may comprise backgrounds, stickers, windows and frames, scenes, wallpapers, sounds such as instruments, sound effects, melodies, video clips, music, animations, etc.

Further categorization of the data is achieved by drop down menus 140 and 145. In FIGS. No. 2 and 3, pre-provided media is displayed within the window of the common user interface. More specifically, as indicated by menus 140 and 145, all backgrounds available to the user are displayed.

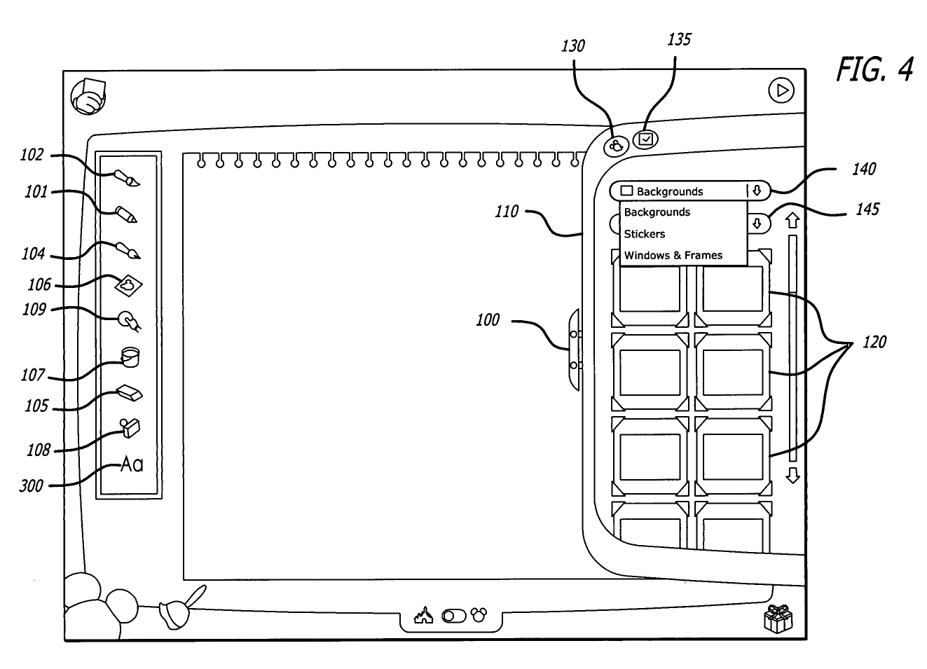

FIG. 4 illustrates how drop down menu 140 provides further categorization of the data. In this example, the user can choose to view media assets of type backgrounds, stickers, or windows and frames.

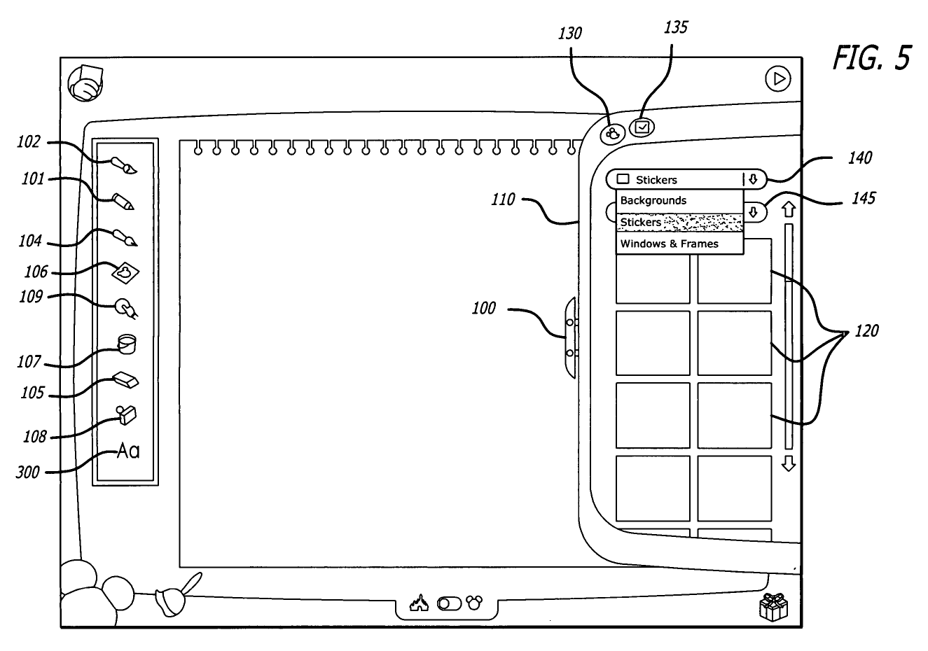

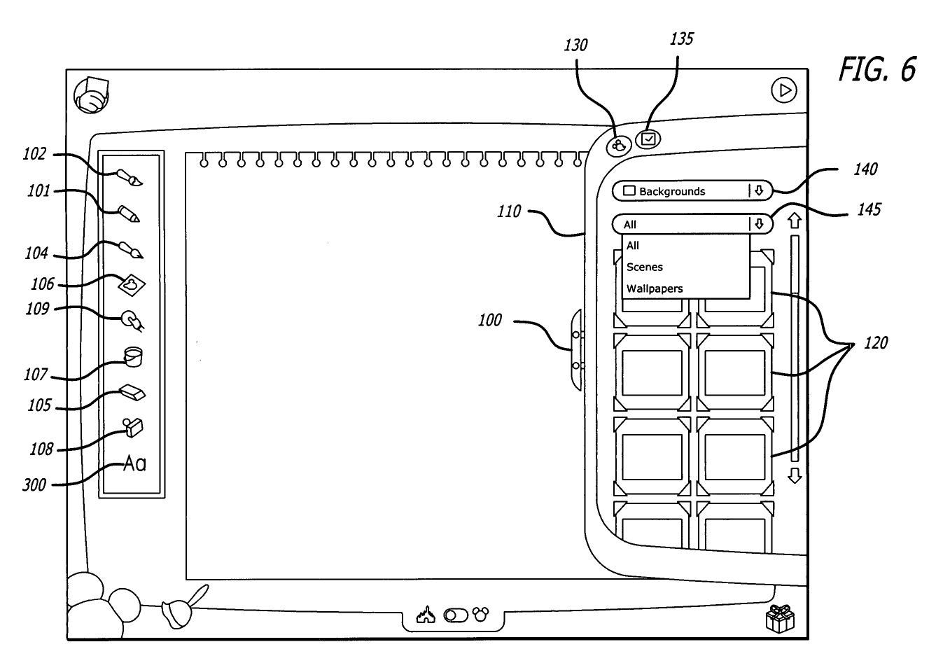

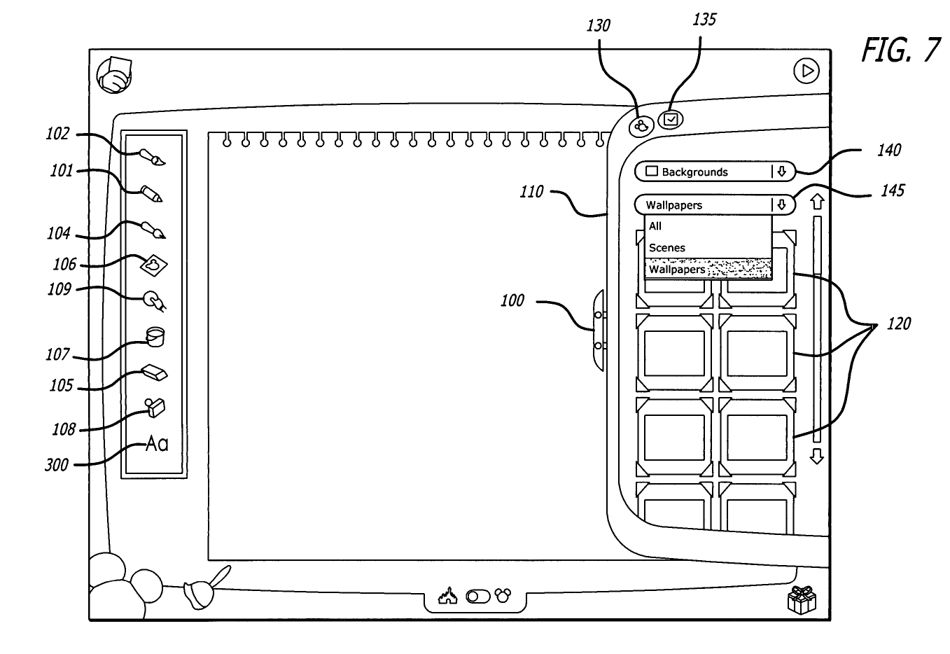

FIGS. 5-7 illustrate screen shots of various other types of data within the pre-provided media category as displayed in the common user interface. That is, stickers are shown in images 120 in FIG. 5; all backgrounds are shown in images 120 in FIG. 6; and wallpapers are shown in images 120 in FIG. 7.

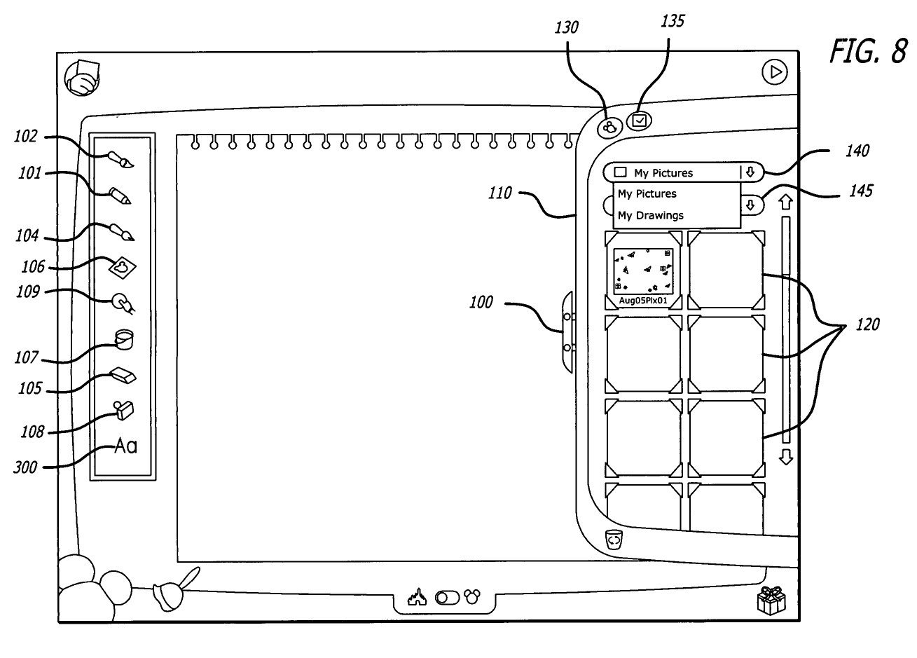

FIG. 8 is another screen shot of an exemplary common user interface for accessing files in accordance with the present disclosure. In FIG. 8, icon 135 is highlighted, which displays media assets that have been created by the user. In one embodiment, the common user interface automatically displays files located within the “My Documents” folder of the Windows operating system. A photo or picture dated Aug. 5 is displayed in image 120.

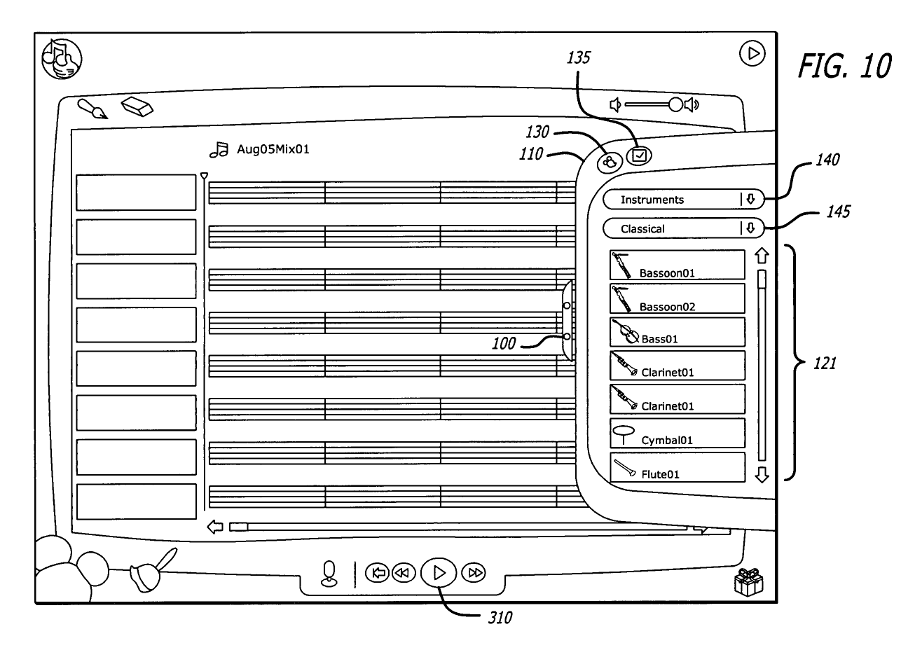

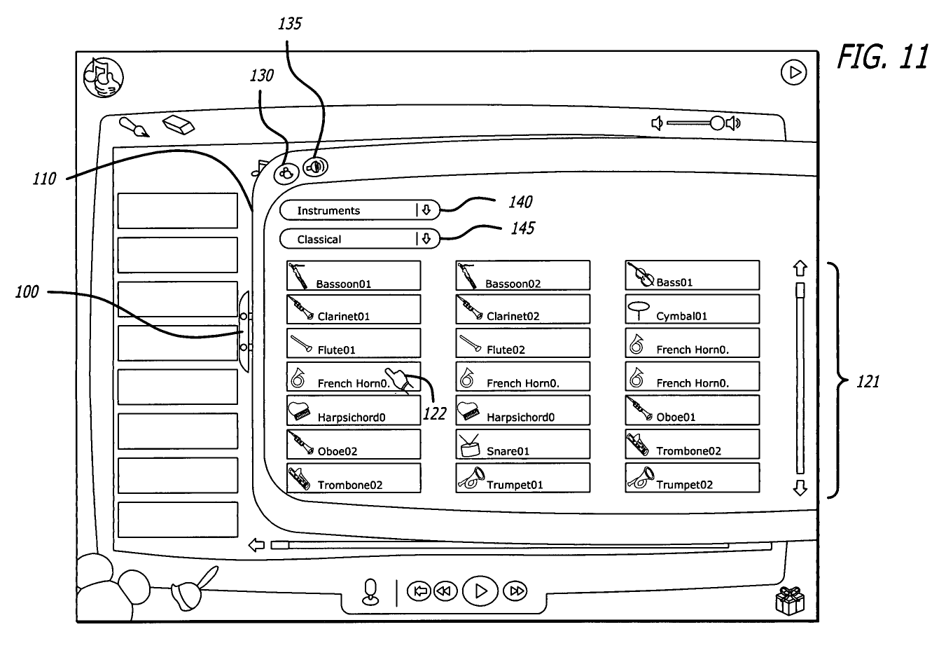

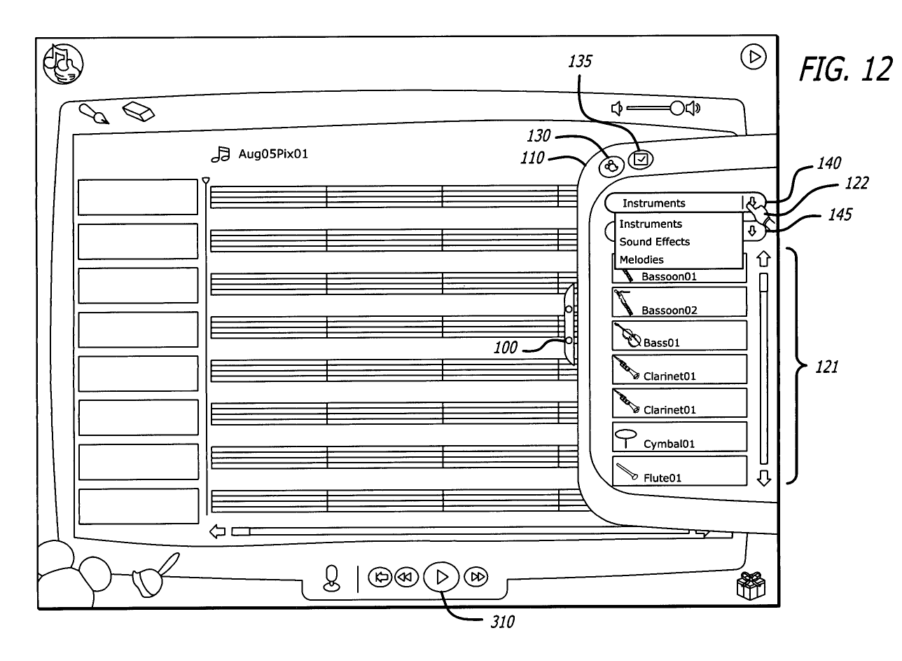

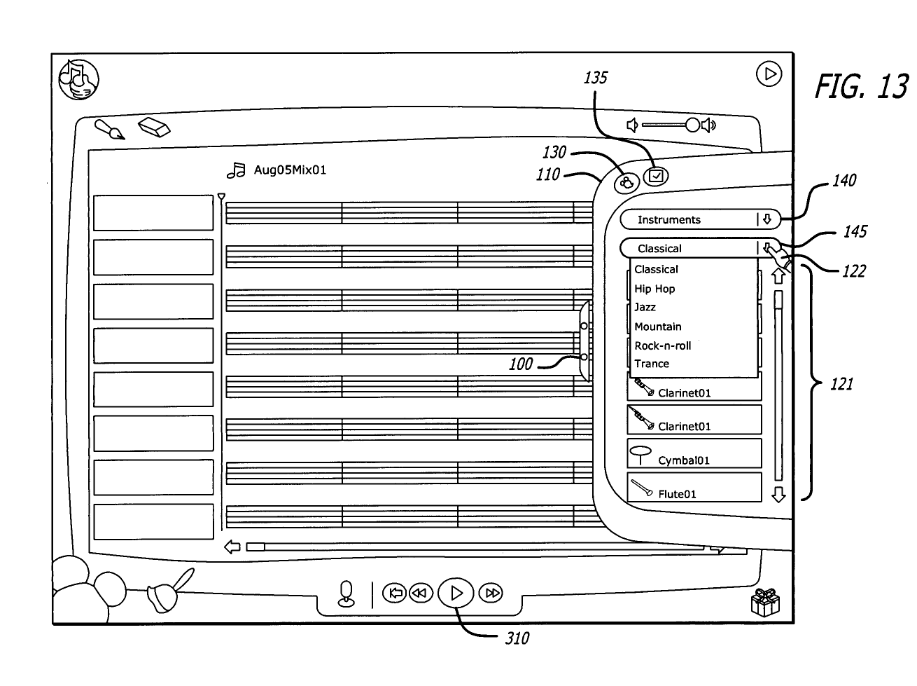

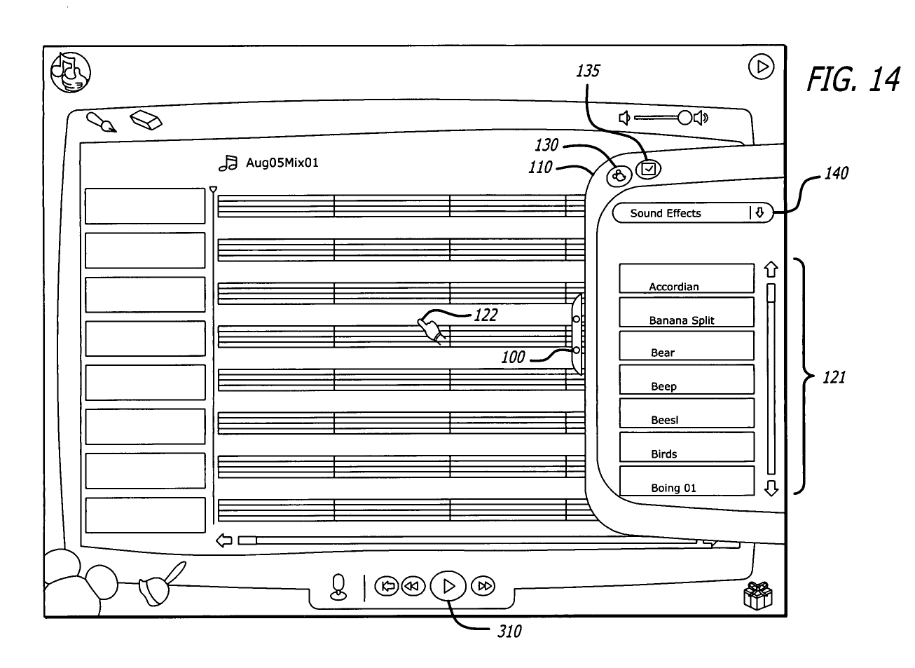

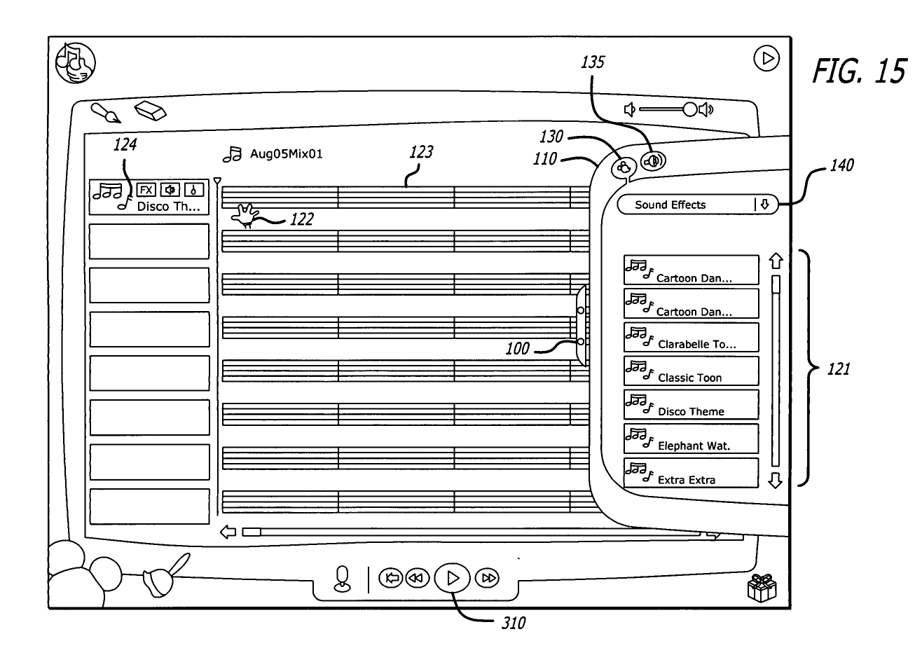

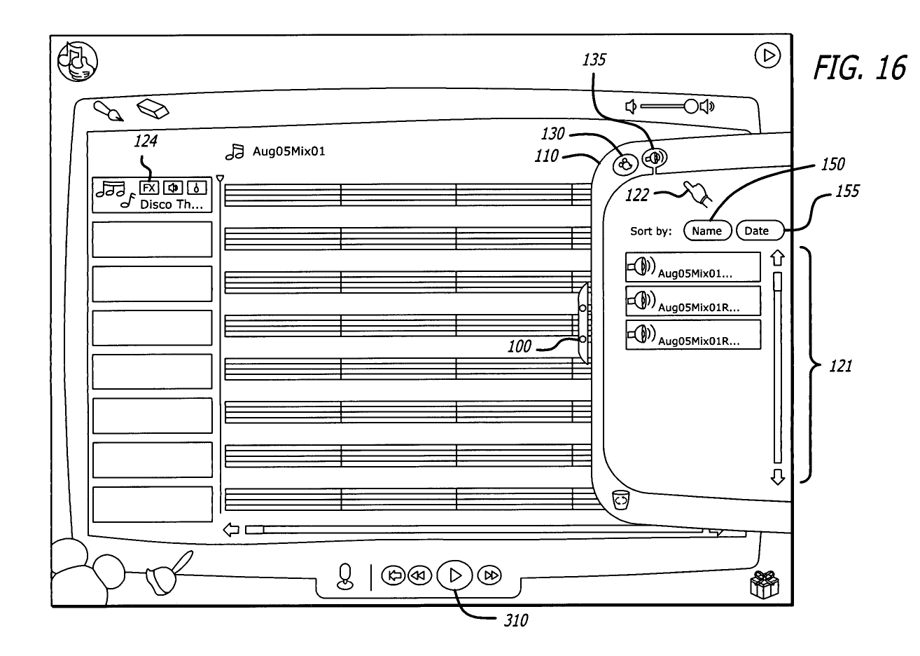

FIGS. 9-16 are screen shots of the common user interface as accessed from a second application. In this embodiment, the second application is an audio creation application. Thus, handle 100 (FIG. 9) opens window 110 (FIG. 10) which shows various instruments that can be selected in images 121. A full expansion of the images 121 is shown in FIG. 11. Note the hand icon 122 points to one of the French Horn selections. Note in FIG. 12 that the hand icon 122 points to “Instruments” and opens that sub-menu. In FIG. 13, the hand icon 122 points to the Classical bar and opens that sub-menu. In FIG. 14, the sound effects bar 140 has been selected and the hand icon 122 points to the musical score sheet 123. In FIG. 15, the Melodies bar 140 has been selected and the hand icon 122 is open at the beginning of the musical score sheet. Various tempos can be selected at bar 124. In FIG. 16, the option of sorting the various files can be carried out by sorting by name or date by accessing buttons 150, 155, respectively.

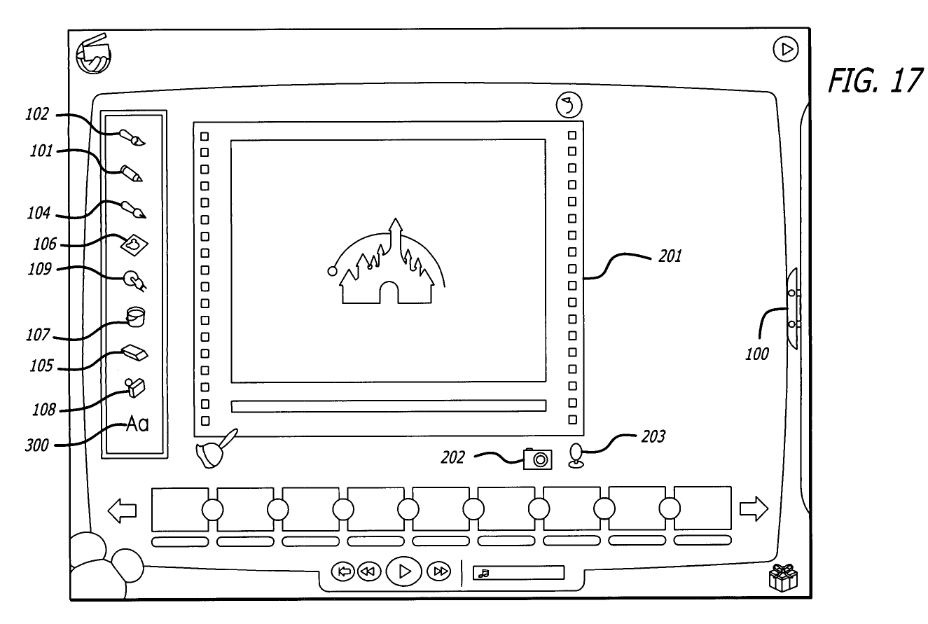

Thus, FIG. 17 illustrates a third application that, as will be discussed, can display data created in one of the applications illustrated in FIGS. 1 to 16 hereinabove. A pictorial illustration 200 is thus displayed in FIG. 17 on a simulated piece 201 of a movie reel. A camera icon 202 and mike icon 203 for video and sound, respectively, are provided at bottom.

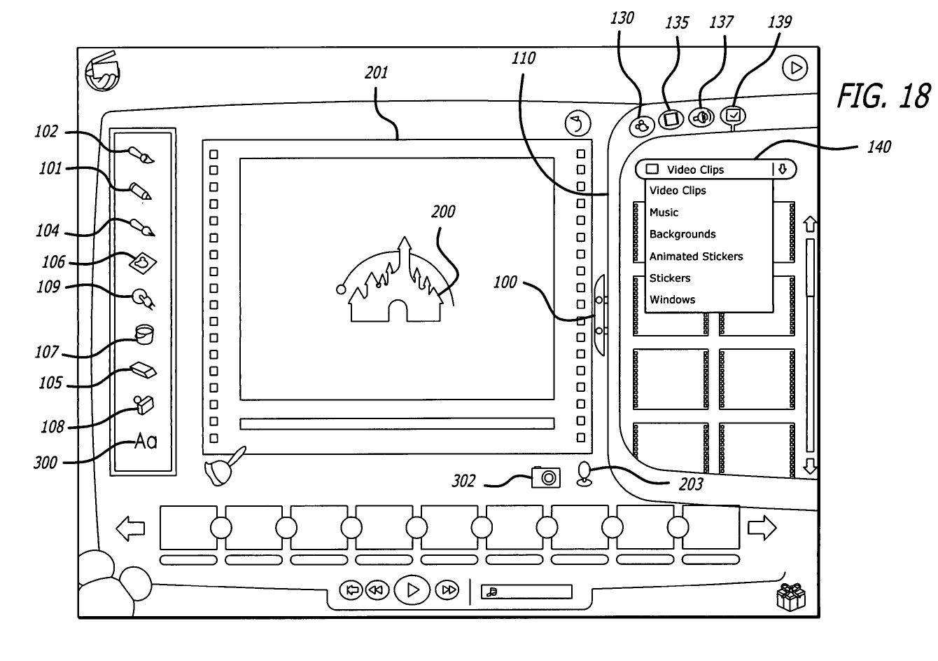

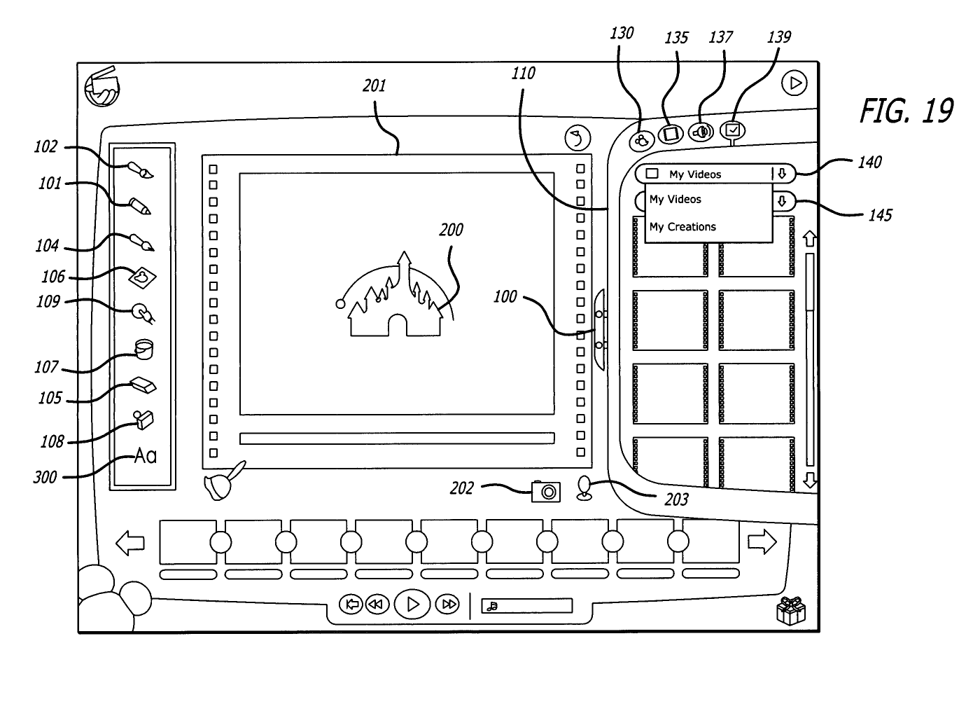

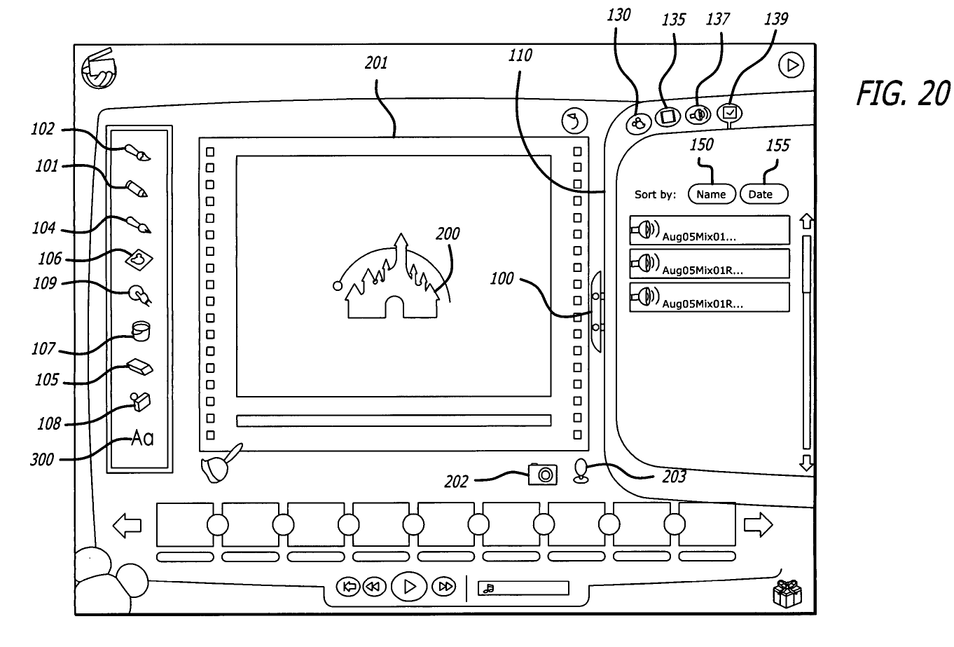

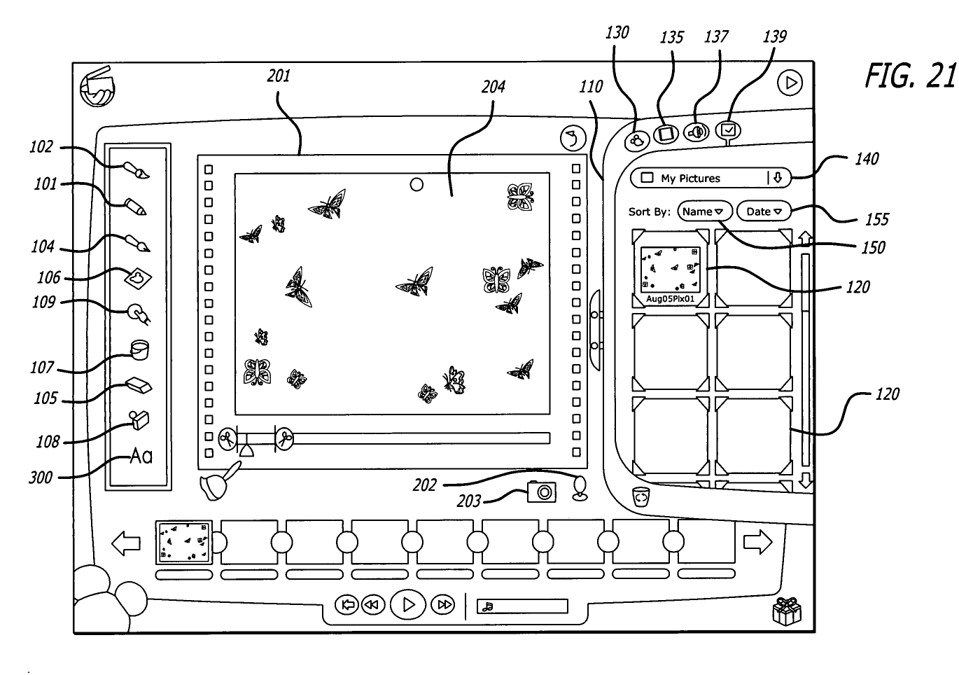

As seen in FIG. 18, icon 137 can be actuated to display data as created in the audio creation application illustrated in FIGS. 9 to 16 and discussed hereinabove, and such can be imported into the application illustrated in FIGS. 17 to 21. Icon 139 displays data as created using an image creation program, as illustrated in FIGS. 1 to 8, and discussed hereinabove. Bar 140 illustrates how Video Clips can be selected to access the pull-down submenu. In FIG. 19, bar 140 illustrates how My Videos is selected and button 145 illustrates how My Videos and My Creations can be selected. FIG. 20 illustrates how the Name button 150 and the Date button 155 can be activated to select a special date, mix, etc. In FIG. 21, the image 204 has been changed when one of the pictures 120 is selected.

It can be seem that there is disclosed an interface for accessing media in a computer or the like wherein the user can access content within an image creation application, an audio creation application or within a video creation application. The various applications can be intermixed; that is, the audio creation may be incorporated into the video creation application, etc. All applications share consistent visual and interaction design and are self-contained but, whereas data editing is only performed in the primary application, e.g., sound editing functions only available in the music application, edited content is accessible from all applications; conventional computer interactions, such as drag and drop, right clicking, window panels, scroll bars, pop up windows, etc., which the user may already familiar with, are supported.

The image creation application of FIGS. 1 to 8 can be used to organize and view all media, such as photos, graphics, and create multi-media documents and showcases. The audio creation application of FIGS. 9 to 16 can be used for creating, editing and listening to edited music and sound. The video creation application can be used to edit video clips, create and view movies with sound, animation, transitions and special effects.

Text, graphics and animation familiar to the user may be used throughout. Navigation through the various menus in FIGS. 1 to 21, is by default, primarily visual via animated icons and thumbnails. Media player functionality is provided where possible so the user can preview files and play groups of files easily, e.g., run a slideshow by selecting a folder or image. The Music application in FIGS. 9 to 16 provides a fun way for users to create music and sound effects. These can then be easily imported into other applications and shared among friends and family. The Music application comes with predefined (generic and themed) instruments, sound effects, and soundtracks suitable for use with the applications in FIGS. 1 to 8 and 17-21. Users can record their own vocals and share their music and sounds with others.

Thus, music can be created, edited, etc. The user can immediately play back his or her creation and share the same with others, if desired. This can easily be provided using a “Send” button for email or web transfer.

The Video Creation application of FIGS. 17 to 21 enables users to capture, import, organize, edit, and share digital video. It includes stock video and transition effects that can be used to create professional-quality digital movies. This application is capable of importing graphics, digital photos, and sound from the other applications. The application is also capable of sophisticated but very simple to use sharing capabilities: digital videos can be compressed and emailed directly from the application window. Users can still watch their movies and DVD's.

The first step in creating a movie is to assemble materials and to support this the movie application will allow numerous import modes. However, the default import experience for users of this system will be completely transparent: when the user plugs in a video camera it may be immediately recognized, auto-launch the application and display the available clips. If a project is started, it adds the clips to that project.

Likewise importing other media types will be automated so that users don't need to fiddle with complex compression settings but any video and audio source imported into the application will be recognized and recompressed. Audio, video and graphic files in many formats and codecs may be supported.

Similarly, FIGS. 17-21 are screen shots of the common user interface as accessed from a third application. In this embodiment, the third application is a video creation application. As can be seen from the figures, the “look and feel” of the common user interface is the same across all three of the applications in FIGS. 1 to 21.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A common user interface for accessing media files comprising:
a resizable window that is common to a plurality of applications, the resizable window displaying a preview image of each of a plurality of media files and providing access to the plurality of media files for use in at least one of a plurality of applications.

2. The interface of claim 1 wherein the resizable window is viewable from within at least one of a plurality of said applications.

3. The interface of claim 1 wherein the resizable window includes at least one drop down menu for filtering the display of media files by type.

4. The interface of claim 1 wherein the resizable window displays files located in a pre-determined folder.

5. The interface of claim 1 wherein the resizable window includes at least one button for sorting the display of media files by name.

6. The interface of claim 1 wherein the resizable window includes at least one button for sorting the display of media files by date.

7. The interface of claim 1 wherein one of the plurality of applications is an audio application.

8. The interface of claim 1 wherein one of the plurality of applications is an image application.

9. The interface of claim 1 wherein one of the plurality of applications is an video application.

10. The interface of claim 1 wherein said interface is displayed on the screen of a computer.

11. The interface of claim 1 wherein one of the plurality of applications is an image application, said image application including image creation means for creating an image.

12. The interface of claim 11 screen and wherein said interface includes a computer screen and said image creation means includes a plurality of tools for drawing images on said screen.

13. The interface of claim 1 wherein one of the plurality of applications is an audio application, said audio application including audio creation means for creating audio programs comprised of one or more musical instruments.

14. The interface of claim 13 including playback means for playing back said created audio programs.

15. The interface of claim 13 wherein said interface includes a computer screen and said audio creation means includes music recording means for recording music displayed on said computer screen.

16. The interface of claim 1 wherein said interface includes a computer with a screen and said one of the plurality of applications is a video application, said video application including video creating means for creating videos viewable on said computer screen.

17. The interface of claim 16 including a plurality of tools associated with said interface for creating drawings viewable on said computer screen.

18. The interface of claim 16 including audio creating means for creating audio audible on said computer associated with said videos.
